(19) United States
(12) Patent Application Publication
(10) Pub. No.: US 2024/0304086 A1
(43) Pub. Date: Sep. 12, 2024

(54) Method for mixing scheduled and unscheduled vehicles

(71) Applicant: DROMOS TECHNOLOGIES AG, München (DE)

(72) Inventor: Martin Dürr, München (DE)

(21) Appl. No.: 18/270,965

(22) PCT Filed: Jan. 7, 2022
(86) PCT No.: PCT/EP2022/050239

§ 371 Date: Jul. 5, 2023

(30) Foreign Application Priority Data
Jan. 7, 2021 (GB) 2100179.7

(51) Int. Cl. G08G 1/0967; G08G 1/01; G08G 1/0968; G08G 1/123

(52) U.S. Cl. CPC G08G 1/096725; G08G 1/0133; G08G 1/0141; G08G 1/0145; G08G 1/096811; G08G 1/096844; G08G 1/123

(57) ABSTRACT

A method for parallel use of a reserved road space in a transportation network by a plurality of scheduled vehicles and a plurality of unscheduled autonomous vehicles is disclosed. The method comprises determining a route for the unscheduled autonomous vehicles travelling in the transportation network. The route is use for travelling from an origin to a destination in the transportation network. The method further comprises predicting conflicts for the unscheduled autonomous vehicles with the scheduled vehicles when travelling in the reserved road space. Predicting the conflicts is done using the selected route and items of the interaction data for the plurality of scheduled vehicles. The method also comprises generating conflict avoidance instructions for the unscheduled autonomous vehicles in order to avoid the predicted conflicts with the scheduled vehicles.

### CROSS REFERENCE TO RELATED APPLICATIONS

This application is a U.S. National Stage of PCT/EP2022/050239, filed on Jan. 7, 2022, which claims priority of the British Patent Application number GB 2100179.7, filed on 7 Jan. 2021. The entire disclosures of the above-referenced applications are hereby incorporated herein by reference in their entirety.

### BACKGROUND OF THE INVENTION

### Field of the Invention

The invention relates to a system and method for operation of a transportation network for a plurality of scheduled vehicles and a plurality of unscheduled autonomous vehicles.

### Brief Description of the Related Art

The term “automated transit network” or “automated transportation network” (abbreviated to ATN) is a relatively new designation for a specific transit mode that falls under the larger umbrella term of “automated guideway transits” (AGT). Before 2010, the name “personal rapid transit (PRT)” was used to refer to the ATN concept. In Europe, the ATN has been referred to in the past as “podcars”. This document sets out a system and method for improving the routing of autonomous vehicles in an autonomous transportation network.

Like all forms of AGT, ATN is composed of autonomous vehicles that run on an infrastructure and are capable of carrying passengers from an origin to a destination. The autonomous vehicles are able to travel from an origin stop at the origin of the passenger's journey to a destination stop at the destination without any intermediate stops or transfers, such as are known on conventional transportation systems like buses, trams (streetcars) or trains. The ATN service is typically non-scheduled, like a taxi, and travelers are able to choose whether to travel alone in the vehicle or share the vehicle with companions.

The ATN concept is different from self-driving cars which are starting to be seen on city streets. The ATN concept has most often been conceived as a public transit mode similar to a train or bus rather than as an individually used consumer product such as a car. Current design concepts of the ATN rely primarily on a central control management for controlling individually the operation of the autonomous vehicles on the ATN.

On the other hand, the self-driving cars are often described as being “autonomous”, but in practice, there are different classes or levels of vehicle autonomy. The degree of vehicle autonomy is typically divided in five levels, as set out by the On-Road Automated Driving (ORAD) committee of the Society of Automotive Engineers (SAE) in “Taxonomy and definitions for terms related to driving automation systems for on-road motor vehicles” published in Recommended Practice SAE J 3016 on 15 Jun. 2018. Level 0 refers to a vehicle that has no driving automation. The driver of the vehicle is fully in charge of operating the movement of the vehicle. Vehicles of Level 0 may include safety systems such as, for example, a collision avoidance alert. Level 1 refers to vehicles having at least one driving assistance feature such as an acceleration or braking assist system. The driver is responsible for the driving tasks but is supported by the driving assist system which is capable of affecting the movement of the vehicle. Level 2 describes vehicles having more than one assist system for actively affecting the movement of the vehicle. The driver, in Level 2, is still responsible for the driving tasks and must actively monitor the trajectory of the vehicle at all times. The driver is, however, actively supported by the assist systems. Level 3 describes a so-called “conditional automation” of the vehicle. The vehicle is capable of autonomously driving in certain situations and with limitations. The driver is not required to actively monitor the assist system but is, however, required to take control of a driving situation if requested by the assist system. Level 4 describes autonomously travelling vehicles which are capable of travelling specific routes under normal conditions without human supervision. The vehicles of Level 4 can therefore operate without a driver but might need remote human supervision in case of conflict situations, travelling in remote areas, or when travelling in extreme weather conditions. Level 5 Automation describes fully autonomously driving vehicles. No human interaction is required at any time for the operation of the vehicles.

A report on “Automated Transit Networks (ATN): A Review of the State of the Industry and Prospects for the Future” published by the Mineta Transportation Institute, Report No 12-31 in September 2014 reported that at the date of writing no ATN having more than ten stations had been implemented in the world. Currently the ATN networks operate on the principle of mapping each origin to all of the destinations. This leads to a matrix with 20 entries even for a simple five-station system as there are four possible destinations from each of the five origins. A ten-station system would have 90 possible routes and it will be seen that as the number of origins and destinations increases, then an O/D matrix listing all of the possible routes will expand out of hand. The current systems are therefore not scalable.

One of the bottlenecks in an operation of the ATN is the efficient use of the existing road- or traffic space. Many cities have introduced concepts of bus-only-lanes, HOV-lanes, or similar concepts of reserved road space. In many cases, only scheduled vehicles, such as buses or trams, are allowed on these reserved road spaces. This allows the scheduled vehicles to travel mostly independent from regular traffic, but also leaves the reserved road space unused for significant amounts of time. For example, bus lanes are often intensively used during morning and evening rush hours, whereas outside of these peak periods, the bus lanes are used much less extensively by the public transit vehicles. The reserved road space is therefore often not intensively used by public transit vehicles. The transportation network of this document enables the shared use of the reserved road spaces by the autonomous unscheduled vehicles during peak periods as well as off-peak periods and provides an infrastructure to enable this shared use to be managed. This allows for the more efficient use of the existing reserved road space and avoids the need to create additional road space for the transportation of the passengers.

U.S. Pat. No. 10,580,298 B1 teaches a system for providing vehicles with instructions for operation on a roadway portion. The roadway portion may be one or more lanes in a segment of a roadway. A first set of vehicles may be equipped with a communication device for communication with one or more servers configured to provide instructions and/or other information. One or more objects at or near the roadway portion may be identified. A presence of a first object not in the first set of vehicles may be detected. The first object may not include a communication device. A warning notification may be provided to vehicles at or near the roadway portion when the first object is detected. Instructions to perform one or more driving maneuvers may be provided to vehicles at or near the roadway portion when the first object is detected. US '298 also discloses a system for notifying vehicles of objects on the roadway portion and sending driving maneuver instructions to the vehicles. The system does not, however, disclose managing the use of reserved road space using a control management center.

U.S. Pat. No. 10,152,053 B1 describes an autonomous vehicle management system and a method for controlling the fleet of vehicles. It describes a system comprising a plurality of autonomous vehicles having an onboard processor and vehicle memory for calculating a route. The system further comprises a control management center and a plurality of infrastructure elements. The infrastructure elements transmit information and data to control the autonomous vehicles. US '053 does not, however, disclose calculation of routes for the autonomous vehicles independently of each other by the autonomous vehicle and by the control management center.

U.S. Pat. No. 8,116,969 B2 discloses a method for equalizing traffic flows in a transportation network using a control computer. The control computer stores information on the routes in the network (as vectorized graphs) extending from an origin to a destination. The route network contains multiple branch points creating separate branches of the routes for the travelling of the vehicles. At least some of the vehicles send a unique vehicle identifier and their current position to the traffic control computer. The document also discloses a method for producing and transmitting the route recommendation to the vehicles. The route recommendation includes sending a so-called distribution ratio V to the vehicles. The distribution ratio V indicates a value to ensure that the vehicles are distributed statistically over more than one route from the origin to the destination and indicates to a vehicle which branch of the route should be taken at the branch point. to the vehicles. The vehicles themselves then calculate alternative routes from the origin to the destination using a randomized selection scheme upon receiving the distribution ratio V. The document reveals a further method for producing and transmitting the individual route recommendations to the vehicles. This method includes briefly connecting a communication system, mounted close to the road, via wireless communication to the vehicle. Different route recommendations are alternately sent to the passing vehicles.

US '969 teaches a concept aiming at equalizing traffic flows between multiple branches (or road segments) of a transportation network. The concept is based on the idea of diverging traffic from highly frequented branches by randomly assigning oncoming vehicles diversion information. The vehicles then calculate the new routes independently and without communicating these calculated new routes back to the control computer. The document does not, however, disclose a system being aware of all the movements of the vehicles within the system. No concept of a parallel calculation of the routes around potential conflicts in the control center and the vehicles is disclosed.

US Patent Application No. US 2018/203457 A1 discloses a method for avoiding interference with a bus. The method includes detecting a bus and obtaining image data from the bus, such as information displayed on the bus. A deep neural network trained on bus images may process the information to associate the bus with a bus route and stop locations. Map data corresponding to the stop locations may also be obtained and used to initiate a lane change or safety response in response to proximity of the bus to a stop location. A corresponding system and computer program product is also disclosed in the US '457203457. The method disclosed does not teach solutions for the parallel operation of scheduled and unscheduled vehicles on the reserved road space.

Chinese Patent Application No. CN 111210618 A discloses an autonomous transportation network which provides integrated control and operation for automated vehicles. The system comprises a roadside network, a traffic control unit, and a traffic control center. The system further comprises an in-vehicle unit, a vehicle interface, a traffic operation center, and a cloud-based information and computing service platform. The autonomous transportation network is used for sensing, predicting, and managing traffic behavior. The network is further used for planning and controlling routes of a plurality of vehicles in the network. The document does not, however, disclose a method for independently predicting conflicts between scheduled vehicles and unscheduled vehicles and for generating, using the conflicts, conflict avoidance instructions.

### SUMMARY OF THE INVENTION

The present document describes a system and method for parallel operation of a plurality of scheduled vehicles and a plurality of unscheduled autonomous vehicles in a transportation network. The scheduled vehicles are, for example, a bus, a cable-car, a tram, a streetcar, or other types of public transit vehicles operating on the reserved road space. The unscheduled autonomous vehicles are, for example, autonomously driving vehicles containing a vehicle processor, a vehicle memory, and a vehicle antenna. The transportation network comprises a plurality of roads with at least one reserved road space for sharing between the scheduled vehicles and the unscheduled autonomous vehicles. The reserved road space can be, for example, a bus-lane, a HOV-lane, a fire-lane, an emergency lane, or other types of restricted access roads within the transportation network.

The transportation network described in the present document is a deterministic system comprising a plurality of stops or stations for travelling from an origin to a destination. Possible routes for travelling between the stations by the scheduled vehicles and the unscheduled autonomous vehicles are pre-determined and stored in a structure model. The structure model comprises items of data for further identifying restrictions of the routes or the stops. A control management center is aware of the scheduled vehicles and the unscheduled autonomous vehicles travelling in the transportation network. The control management center is also aware of the restrictions and possible conflicts on the routes. The unscheduled autonomous vehicles include assist systems of Level 2 or Level 3, as described above. Using the items of data stored in the structure model and knowing the restrictions and possible conflicts on the routes from the control management center, the unscheduled autonomous vehicles are aware of possible conflict situations when autonomously travelling in the transportation network. The unscheduled autonomous vehicles, therefore, do not require a driver for driving of the unscheduled autonomous vehicle.

The system contains a public transit communication unit for communicating with a public transit management center. The public transit communication unit is also used for receiving scheduled vehicle data relating to the locations of ones of the plurality of scheduled vehicles. The system further contains an infrastructure communications unit for communicating with a plurality of infrastructure elements. The infrastructure communications unit is also used for communicating with the unscheduled autonomous vehicles and for receiving unscheduled vehicle data relating to the locations of the unscheduled autonomous vehicles.

The system also contains a control management processor for calculating conflict avoidance instructions using the scheduled vehicle data and the unscheduled vehicle data. The system further comprises a central memory for storing a structure model indicating the structure of the transportation network and a scheduled traffic pattern model. The scheduled traffic pattern model includes items of data for the scheduled vehicles operating in the transportation network and the stations disposed in the network. The items of data include, for example, a scheduled arrival time, a scheduled departure time, a scheduled dwell time for the stations.

The present document further describes a method for parallel use of the reserved road space by the scheduled vehicles and the unscheduled autonomous vehicles operating in the transportation network. The method comprises determining a route from an origin to a destination for the unscheduled autonomous vehicles travelling in the transportation network. The method further comprises predicting, using the determined route, conflicts between the scheduled vehicles and the unscheduled autonomous vehicles. The predicting of the conflicts is done using the scheduled traffic pattern model. The method is then used for generating, using the predicted conflicts, conflict avoidance instructions for the unscheduled autonomous vehicles. The generated conflict avoidance instructions are sent to infrastructure elements for the transmission of the conflict avoidance instructions to the unscheduled autonomous vehicles. Using the conflict avoidance instructions, the unscheduled autonomous vehicles can adjust their route to avoid the conflict with the scheduled vehicles. The adjusting of the route is done by the unscheduled autonomous vehicle independently. The control management center and the unscheduled autonomous vehicles calculate, using a structure model, the route independently to avoid the predicted conflicts. The structure model is a model of the structure of the transportation network with the routes on which the unscheduled autonomous vehicles can travel.

### BRIEF DESCRIPTION OF THE FIGURES

FIG. 1 shows an overview of the system.

FIG. 2 shows an overview of the operation of the system.

FIG. 3 shows the prediction of the conflicts.

### DETAILED DESCRIPTION OF THE INVENTION

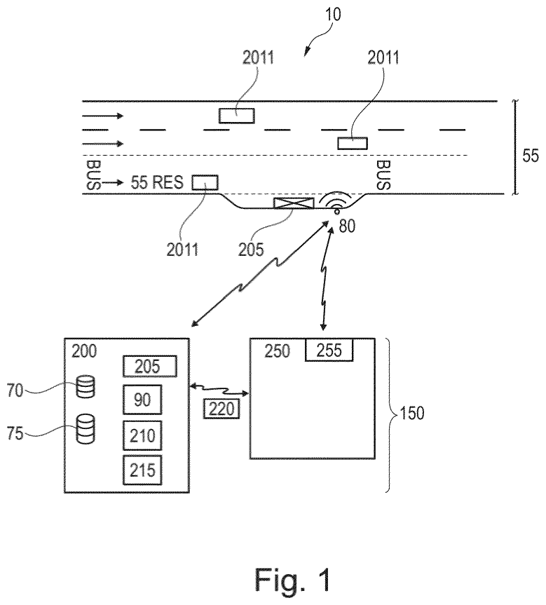

A system 150 for operation of a transportation network 10 is shown in FIG. 1. The transportation network 10 has a plurality of scheduled vehicles 20S, such as buses, trams, or trolleybuses, and a plurality of unscheduled autonomous vehicles 20U. The system 150 has a control management center 200 for controlling and monitoring the plurality of unscheduled autonomous vehicles 20U, a transit management center 250 for monitoring the plurality of scheduled vehicles 20S, and a transit communications unit 220 for communication between the control management center 200 and the transit management center 250. The functions of the control management center 200 and the transit management center 250 will be explained in more detail later. It will be appreciated that the control management center 200 and the transit management center 250 do not need to be co-located. It will also be appreciated, that the control management center 200 and the transit management center 250 can be operated by different entities such as a public transit provider and a private provider of autonomous mobility solutions. The control management center 200 and the transit management center 250 can be located in cloud solution(s).

The scheduled vehicles 20S in this part of the transportation network 10 run on a reserved road space 55RES which could be, for example, a bus lane reserved for use by buses or a tram track used by trams (streetcars) and/or other public transportation vehicles. The scheduled vehicles 20S can also run on regular roads. The scheduled vehicles 20S are scheduled to stop at stations or stops 57 to pick up and set down passengers from the scheduled vehicles 20S.

The unscheduled autonomous vehicles 20U are described in more detail in the Applicant's co-pending UK patent application GB2005607.3 filed on 17 Apr. 2020, the contents of which are incorporated by reference. The unscheduled autonomous vehicles 20U are autonomously driving vehicles and include a vehicle processor 27 for operation of the unscheduled autonomous vehicles 20U and calculation of routes 50, a vehicle memory 28 which includes a map storage area for the storage of at least part of the map of the transportation network 10, and a vehicle antenna 25 to enable communication with infrastructure elements and control centers as will be described below. The unscheduled autonomous vehicles 20U travel autonomously in the autonomous transportation network 10, independently determining and travelling the route 50 from an origin 30 to a destination 35 along the road 55. The unscheduled autonomous vehicles 20U travelling in the autonomous transportation network 10 are independent and are not in communication with one another.

It is known that the reserved road spaces are not intensively used by the scheduled vehicles 20S. For example, bus lanes are often intensively used during morning and evening rush hours, whereas outside of these peak periods, the bus lanes are used much less extensively. The transportation network 10 of this document enables the shared use of the reserved road spaces 55RES by the unscheduled autonomous vehicles 20U during peak periods as well as off-peak periods and provides an infrastructure to enable this shared use to be managed.

Most modem bus and tram networks include the transit management center 250 in which a plurality of the scheduled vehicles 20S communicate with the transit management center 250 through a vehicle communication unit 255. In one aspect of the present invention, all of the scheduled vehicles 20S are able communicate with the transit management center 250. However, in another aspect of the present invention, some of the scheduled vehicles 20S are not capable of communicating with the transit management center 250. It will be possible to retrofit some or all of the scheduled vehicles 20S with equipment to enable communication with the transit management center 250. The transit management center 250 knows the timetables according to which the scheduled vehicles 20S run and is able to receive, at regular intervals, scheduled vehicle data relating to the locations of the plurality of scheduled vehicles 20S on roads 55 or travelling in the reserved road spaces 55RES. The data relating to the location and time stamp of the scheduled vehicles 20S is communicated, for example, through a wireless network. Many of the scheduled vehicles 20S are equipped with a GNSS receiver that is able to determine the location of the scheduled vehicle 20S in the transportation network 10 and the information about the location is transferred together with a time stamp to the transit management center 250 as scheduled vehicle data. It is also possible that the transportation network 10 is equipped with detectors 80 in or near roads 55, the stops or stations 57, and the reserved road spaces 55RES to detect the scheduled vehicles 20S at particular locations. This information regarding the detected position of the scheduled vehicles 20S within the transportation network 10 can also be transferred to the transit management center 250 as the scheduled vehicle data.

The transportation network 10 also includes an infrastructure communications unit 215 for communicating with a plurality of infrastructure elements in the transportation network 10. The infrastructure elements may be simply radio beacons that transmit information to the unscheduled autonomous vehicles 20U or may include additional elements such as control elements for traffic signals, such as traffic lights, to control flow of the scheduled vehicles 20S in the transportation network. The infrastructure elements receive unscheduled vehicle data relating to the locations of the plurality of unscheduled autonomous vehicles 20U in the transportation network 10 and can send this unscheduled vehicle data to the infrastructure communications unit 215.

A control management processor 205 uses scheduled vehicle data (communicated from the transmit management center 250 through the transit communication unit 220) and the unscheduled vehicle data and is able to simulate the traffic pattern in the transportation network 10 for both the scheduled vehicles 20S and the unscheduled autonomous vehicles 20U. The control management processor 205 is thus able to predict potential conflicts between the scheduled vehicles 20S and the unscheduled autonomous vehicles 20U sharing the reserved road space 55RES. Control management processor 205 calculates conflict avoidance instructions 50AVD should a conflict be detected. The conflict avoidance instructions 50AVD are sent to some of the infrastructure elements from where the conflict instructions 50AVD are communicated to the unscheduled autonomous vehicles 20U to enable the unscheduled autonomous vehicles 20U, for example, to choose an alternative route and thus avoid the conflict in the reserved road space 55RES and/or possibly slow down in order to give priority to the scheduled vehicles 20S entering into, travelling along or exiting the reserved road space 55RES.

In one aspect, the transportation system 150 further comprises a control center memory 210 connected to the control management processor 205 for storing a structure model 75 of the transportation network 10 and a scheduled traffic pattern model 70SCHED with the schedules of the scheduled vehicles 20S. For example, the structure model 75 comprises the roads 55 of the transportation network or the stations 57 disposed in the transportation network 10. For example, the scheduled traffic pattern model 70SCHED can store at least one of a scheduled arrival time, a scheduled departure time, a scheduled dwell time for the stations 57 in the transportation network 10.

The transportation network 10 of this document comprises a plurality of roads 55 on which the scheduled vehicles 20S can run and a plurality of tracks 56 on which the unscheduled autonomous vehicles 20U are able to run, as well as sections on which both the scheduled vehicles 20S and the unscheduled autonomous vehicles 20U can run. Transportation network 10 has several reserved road spaces 55RES which can be shared between the scheduled vehicles 20S and the unscheduled autonomous vehicles 20U. Examples of the reserved road spaces 55RES include the aforementioned bus lanes, a high occupancy vehicle (HOV) lane, a fire lane, an emergency lane, or other types of restricted-access-lanes. It will be appreciated that the reserved road space 55RES may comprise a single one-lane reserved road space, a multi-lane reserved road space, a road space with all lanes travelling in one direction, a road space with lanes travelling in opposite directions, or a road space with lanes being used in both directions.

The unscheduled autonomous vehicles 20U in the transportation network 10 are autonomous vehicles which can travel from the origin 30 to the destination 35 carrying a limited number of passengers. The autonomous vehicles are equipped with a vehicle processor 27 for independently calculating a route from the origin 30 to the destination 35, a vehicle memory 28 storing a plurality of possible routes from the origin to the destination, and a vehicle antenna 25 for communicating with the infrastructure elements. The vehicle antenna 25 comprises a plurality of communications devices such as, but not limited thereto, a RFID-communications unit, an optical communications unit, a UHF-communications unit, and a cellular communication unit.

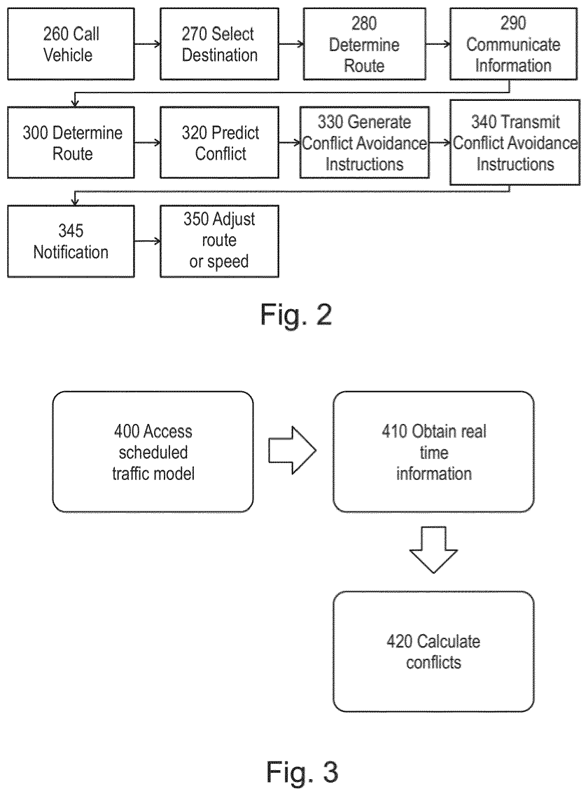

FIG. 2 shows the operation of transportation network 10 to enable parallel use of the reserved road space 55RES by the scheduled vehicles 20S and the unscheduled autonomous vehicles 20U.

In a first step 260 shown in FIG. 2, a passenger will call an unscheduled autonomous vehicle 20U from the origin 30 and select in step 270 the destination 35. The unscheduled autonomous vehicle 20U can determine in step 280, using the vehicle processor 27, the best route for travelling from the origin 30 to the destination 35 using the stored plurality of possible routes in the vehicle memory 28. As is known from co-pending patent application GB2005607.3 this information is communicated to the control management center 200 in step 290.

The control management center 200 independently calculates route 50 to the destination 35. The structure model 75 stored in the unscheduled autonomous vehicles 20U is identical to that structure model stored in the control center memory 210 and thus the control management center 200 will know the route 50 that the unscheduled autonomous vehicles 20U will take between the origin 30 and the destination 35. The control management center 200 therefore knows in step 300 the route 50 from the origin 30 to the destination 35 that will be travelled by the unscheduled autonomous vehicle 20U in the transportation network 10. The control management center 200 will also know whether route 50 includes travelling along a stretch of the reserved road space 55RES. The control management center 200 then predicts in step 320, using the selected route 50 and the items of interaction data 45 for the plurality of scheduled vehicles 20S, potential conflicts 60 between the scheduled vehicles 20S with any of the unscheduled autonomous vehicles 20U travelling in the reserved road space 55RES. The control management center can generate, in step 330, conflict avoidance instructions 50AVD for the plurality of unscheduled autonomous vehicles 20U to avoid the predicted conflicts 60, as noted above.

The predicting in step 330 of the conflicts 60 in the reserved road space 55RES is shown in FIG. 3 in more detail. The prediction 330 can be made initially in step 400 by accessing the scheduled traffic pattern model 70SCHED for the scheduled vehicles 20S. It is well-known that there may be delays in the schedules vehicles 20S and thus in step 410 real-time traffic information about the location of some or all of the plurality of scheduled vehicles 20S is obtained. This is done by obtaining the interaction data 45 from at least one of a plurality of sensing elements 40 in the infrastructure is used to update the traffic pattern model 70SCHED. The potential conflicts 60 are then calculated in step 420. It will be appreciated that it is not necessary to use the scheduled traffic pattern model 70SCHED and that it would be possible to calculate potential conflicts 60 in real time by only using the interaction data 45.

The transmitting in step 340 of the conflict avoidance instructions 50AVD is generally carried out by transmitting the conflict avoidance instructions to the infrastructure elements 80 in the transportation network 10. This can be done either through fixed telecommunications lines or through a wireless network. The communication between the infrastructure elements 80 and the unscheduled autonomous vehicles 20U is then carried out in step 345 by a notification between the infrastructure element 80 and the unscheduled autonomous vehicle 20U using a short-distance low power communications, such as using a Bluetooth or NFC protocol.

As already noted above, it is possible in step 350 to adjust the speeds of the plurality of unscheduled autonomous vehicles 20U to avoid the conflicts 60 as well as adjusting the route 50.

In a further example of the invention, the control management center 200 can also use data from emergency vehicle coordination centers to remove any potential conflicts 60′ between the unscheduled autonomous vehicles 20U and emergency vehicles, such as fire engines or paramedics, in a similar manner.

### REFERENCE NUMERALS

10 Transportation network
20S Scheduled vehicles
20U Unscheduled autonomous vehicles
25 Vehicle antenna
27 Vehicle processor
28 Vehicle memory
50AVD Avoidance Instructions
55 Roads
55RES Reserved road space
56 Tracks
57 Stops or stations
70SCHED Schedules or scheduled traffic pattern model
75 Structure model
80 Detector
150 System for operation of a transportation network
200 Control management center
205 Control management processor
210 Control center memory
215 Infrastructure communications unit
220 Transit communications unit
250 Transit management center
255 Vehicle communications unit

1. A method for parallel use of a reserved road space by a plurality of scheduled vehicles and a plurality of unscheduled autonomous vehicles in a transportation network, the method comprising:
determining for at least one of the plurality of the unscheduled autonomous vehicles a route from an origin to a destination in the transportation network;
predicting, using the selected route and items of the interaction data for the plurality of scheduled vehicles, conflicts for ones of the plurality of scheduled vehicles with ones of the unscheduled autonomous vehicles in the reserved road space; and
generating, using the predicted conflicts, conflict avoidance instructions for ones of the plurality of unscheduled autonomous vehicles for avoidance of the predicted conflicts.

2. The method of claim 1, further comprising
predicting of the conflicts in the reserved road space using a scheduled traffic pattern model.

3. The method according to claim 1, further comprising:
transmitting of the conflict avoidance instructions to infrastructure elements in the transportation network.

4. The method according to claim 1, further comprising:
notifying one or multiple ones of the unscheduled autonomous vehicles to avoid the conflicts using the transmitted conflict avoidance instructions.

5. The method according to claim 1, further comprising:
adjusting speeds of ones of the plurality of unscheduled autonomous vehicles to avoid the conflicts with ones of the plurality of scheduled vehicles travelling in the reserved road space.

6. The method of claim 1, further comprising:
adjusting route for at least one of the unscheduled autonomous vehicles, using the conflict avoidance instructions.

7. The method according claim 1, further comprising:
continuously updating the scheduled traffic pattern model based on travel patterns of the scheduled vehicles using interaction data from at least one of a plurality of sensing elements.

8. A system for operation of a transportation network for a plurality of scheduled vehicles and a plurality of unscheduled autonomous vehicles, the system comprising:
a public transit communication unit for communicating with a public transit management center and receiving scheduled vehicle data relating to the locations of ones of the plurality of scheduled vehicles;
an infrastructure communications unit for communicating with a plurality of infrastructure elements and ones of the plurality of unscheduled autonomous vehicles and receiving unscheduled vehicle data relating to the locations of ones of the plurality of unscheduled autonomous vehicles; and
a control management processor for calculating conflict avoidance instructions from the scheduled vehicle data and the unscheduled vehicle data.

9. The system of claim 8, wherein:
the transportation network comprises a plurality of roads with at least one reserved road space for sharing between the plurality of scheduled vehicles and the plurality of unscheduled autonomous vehicles.

10. The system of claim 8, wherein:
the system further comprises a control center memory for storing of at least one of a structure model and the scheduled traffic pattern model.

11. The system of claim 10, wherein:
the scheduled traffic pattern model stores at least one of a scheduled arrival time, a scheduled departure time, a scheduled dwell time for at least one of the plurality of the stations disposed in the transportation network.

12. The system of claim 8, wherein:
the reserved road space comprises at least one of a bus-lane, a HOV-lane, a fire-lane, an emergency-lane, or other types of a restricted-access-lanes on a road within the transportation network.

13. The system of claim 8, wherein:
the reserved road space comprises at least one of a one-lane reserved road space, a multi-lane reserved road space, a road space with all lanes travelling in one direction, a road space with lanes travelling in opposite directions, or a road space with lanes being used in both directions.

14. The system of claim 8, wherein:
the scheduled vehicles comprise at least one of a bus, a cable-car, a tram, a streetcar, or other types of public transit vehicles operating on the reserved road space on a road within the transportation network.

15. The system of claim 8, wherein:
the unscheduled autonomous vehicles comprise at least one of autonomously driving vehicle comprising at least one of a vehicle processor, a vehicle memory, and a vehicle antenna.
